(19) United States
(12) Patent Application Publication
(10) Pub. No.: US 2015/0328827 A1
(43) Pub. Date: Nov. 19, 2015

(54) IMPRINT APPARATUS AND ARTICLE MANUFACTURING METHOD

(71) Applicant: CANON KABUSHIKI KAISHA, Tokyo (JP)

(72) Inventors: Yoshikazu Miyajima, Utsunomiya-shi (JP); Nobuto Kawahara, Utsunomiya-shi (JP)

(21) Appl. No.: 14/704,383

(22) Filed: May 5, 2015

(30) Foreign Application Priority Data
May 16, 2014 (JP) 2014-101918

(51) Int. Cl. B29C 59/02; B29C 59/00

(52) U.S. Cl. CPC B29C 59/02; B29C 59/002; B29L 2031/772

(57) ABSTRACT

An imprint apparatus includes a substrate holder configured to hold a substrate, wherein the substrate holder includes a plurality of holding areas arranged in a predetermined direction and wherein shapes of the plurality of holding areas are defined to be capable of holding a first substrate in a first external diameter and a second substrate in a second external diameter different from the first external diameter.

### BACKGROUND OF THE INVENTION

1. Field of the Invention

The present invention relates to an imprint apparatus and an article manufacturing method.

2. Description of the Related Art

Refinement of a semiconductor device, a microelectromechanical system (MEMS), or the like is being required, and refined processing technology of molding an uncured resin supplied onto a substrate (wafer) in a mold and forming a pattern on a substrate is attracting attention in addition to conventional photolithography technology. This technology is referred to as imprint technology and enables a refined structure on the order of several nanometers to be formed on the substrate. For example, imprint technologies include a photo-curing method. In an imprint apparatus adopting this photo-curing method, first, an uncured resin (photo-curable resin) is supplied to a pattern formation area on the substrate. Next, the resin on the substrate is brought in contact with the mold in which a pattern is formed (pressed). Then, the resin is cured by radiating light in a state in which the resin and the mold are in contact. The pattern of the resin is formed on the substrate by widening an interval between the substrate and the mold (detaching the mold from the cured resin).

In the imprint apparatus adopting the aforementioned technology, the stress occurring at the time of detaching the mold and the resin may cause distortion of a pattern formed in the resin or the like. For this, the publication of Japanese Unexamined Patent Application, First Publication No. 2010-098310 discloses an imprint apparatus capable of dividing an electrostatic attraction member of the substrate holder into a plurality of attraction blocks and enabling ON/OFF switching of an attraction force to be partially performed by a control apparatus. In addition, the publication of Japanese Unexamined Patent Application, First Publication No. 2012-234913 discloses an imprint apparatus capable of dividing an attraction area of a semiconductor holder and adjusting an attraction force for each area step by step through the control apparatus.

However, in the imprint apparatuses of the publication of Japanese Unexamined Patent Application, First Publication Nos. 2010-098310 and 2012-234913, compatibility with a plurality of substrate sizes of the substrate holder is not considered. According to diversification of substrate sizes, an imprint apparatus having a substrate holder that can be used for different sizes is required.

### SUMMARY OF THE INVENTION

The present invention has been made in view of such circumstances, and, for example, provides an imprint apparatus in which one substrate holder can be shared for substrates of different sizes.

The present invention includes an imprint apparatus that forms patterns on a substrate by bringing a resin applied onto the substrate into contact with a mold, the apparatus including: a substrate holder configured to hold the substrate, wherein the substrate holder includes a plurality of holding areas arranged in a predetermined direction, and wherein shapes of the plurality of holding areas are defined to be capable of holding a first substrate in a first external diameter and a second substrate in a second external diameter different from the first external diameter.

Further features of the present invention will become apparent from the following description of exemplary embodiments with reference to the attracted drawings.

### BRIEF DESCRIPTION OF THE DRAWINGS

FIG. 1 is a schematic diagram illustrating a configuration of an imprint apparatus according to a first embodiment of the present invention.

FIG. 2A is a schematic diagram illustrating a configuration example of an attraction area of a substrate holder according to the first embodiment.

FIG. 2B is a cross-sectional view of an X-axis direction of FIG. 2A.

FIG. 2C is a cross-sectional view of a Y-axis direction of FIG. 2A.

FIG. 3A is a diagram illustrating a state in which a substrate having a diameter of 300 mm is held by the substrate holder according to the first embodiment.

FIG. 3B is a diagram illustrating a state in which a substrate having a diameter of 450 mm is held by the substrate holder according to the first embodiment.

FIG. 4A is an explanatory diagram illustrating switching of attraction pressure at a certain shot position of the substrate having the diameter of 300 mm on the substrate holder according to the first embodiment.

FIG. 4B is an explanatory diagram illustrating switching of attraction pressure at a different shot position from FIG. 4A.

FIG. 5A is an explanatory diagram illustrating switching of attraction pressure at a shot position straddling two attraction areas of the substrate having the diameter of 300 mm on the substrate holder according to the first embodiment.

FIG. 5B is an explanatory diagram illustrating switching of attraction pressure at a different shot position from FIG. 5A.

FIG. 6A is an explanatory diagram illustrating switching of attraction pressure at a certain shot position of the substrate having the diameter of 450 mm on the substrate holder according to the first embodiment.

FIG. 6B is an explanatory diagram illustrating switching of attraction pressure at a different shot position from FIG. 6A.

FIG. 7A is an explanatory diagram illustrating switching of attraction pressure at a shot position straddling two attraction areas of the substrate having the diameter of 450 mm on the substrate holder according to the first embodiment.

FIG. 7B is an explanatory diagram illustrating switching of attraction pressure at a different shot position from FIG. 7A.

### DESCRIPTION OF THE EMBODIMENTS

Hereinafter, modes for carrying out the present invention will be described with reference to the drawings and the like.

### First Embodiment

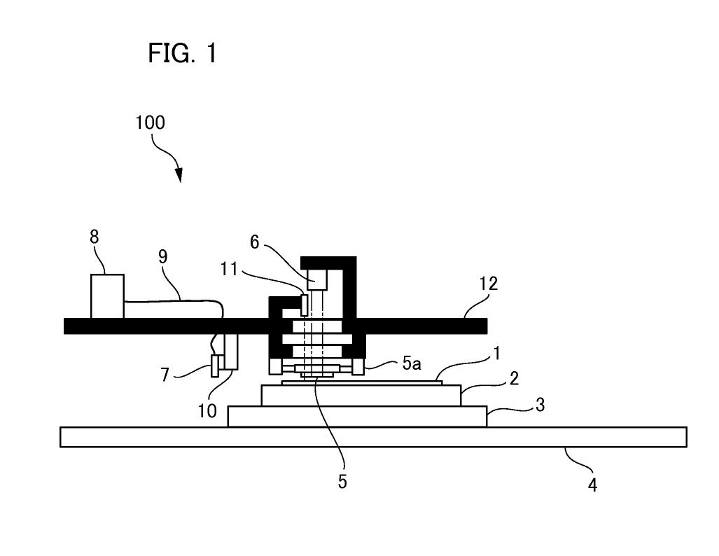

First, an imprint apparatus to which a substrate holder according to the first embodiment of the present invention is applicable will be described. Here, this imprint apparatus includes an ultraviolet (UV) photo-curing type imprint apparatus that cures a resin by radiation of UV light. However, the imprint apparatus may be an imprint apparatus that cures the resin by radiating light of another wavelength band or an imprint apparatus that cures the resin by another form of energy (for example, heat). FIG. 1 is a schematic diagram illustrating a configuration of the imprint apparatus 100 according to this embodiment. The imprint apparatus 100 is configured so that a pattern is formed in a plurality of shot areas of the substrate by iterating an imprint cycle. Here, one imprint cycle is a cycle in which a pattern is formed in one shot area of the substrate by curing the resin in a state in which the mold (original plate) has been pressed on the resin. In a substrate 1, the pattern of the mold is transferred and therefore an element pattern corresponding to the pattern is formed on a surface layer. A fine movement stage 2 is a stage in which the substrate 1 can be driven a very small amount in an XY direction and an XY in-plane rotation direction (about 1 mm in the XY direction and about several degrees in the XY in-plane rotation direction), and a coarse movement stage 3 is a substrate stage that largely moves the substrate 1 in the XY direction. The fine movement stage 2 and the coarse movement stage 3 can move an imprint area from a carry-in/carry-out position of the substrate 1 to the whole surface of the substrate in mutually orthogonal directions. A base frame 4 of the imprint apparatus holds the fine movement stage 2 and the coarse movement stage 3 and performs positioning. A mold 5 has a front surface on which a pattern of a concave/convex shape is engraved. A vertical mold movement means 5a configured to perform vertical driving of the mold 5 performs an operation of bringing the mold 5 in contact with an uncured resin (resist) on the substrate 1 and pressing the mold 5. A UV light generating apparatus 6 causes an uncured resin to be cured by radiating the UV light to the uncured resin via the mold 5. The UV light, for example, includes a light source such as a halogen lamp for generating an i-line and a g-line. In addition, the UV light generating apparatus 6 includes a function of condensing and molding light generated by the light source. A dispenser 7 can coat a predetermined amount of resin on the substrate 1 by forming and ejecting fine droplets of the uncured resin. A tank 8 configured to store the uncured resin supplies the uncured resin to the dispenser 7 through a pipe 9. A moving means 10 configured to move the dispenser 7 between an ejection position and a retracted position (maintenance position) is positioned at the ejection position during a normal ejection operation. The moving means 10 moves the dispenser 7 to the retracted position (maintenance position) and performs cleaning and exchanging of the dispenser 7 during maintenance of the dispenser 7. An alignment scope 11 is a microscope configured to align pattern positions of the mold 5 and the substrate 1 after the uncured resin is coated on the substrate 1 by the dispenser 7. The alignment scope 11 performs mutual position alignment by measuring a state in which an alignment mark provided on the mold 5 and an alignment mark on the substrate 1 overlap using the microscope. A surface plate 12 supports (fixes) the mold 5, the UV light generating apparatus 6, the dispenser 7, the tank 8, the pipe 9, the moving means 10, and the alignment scope 11.

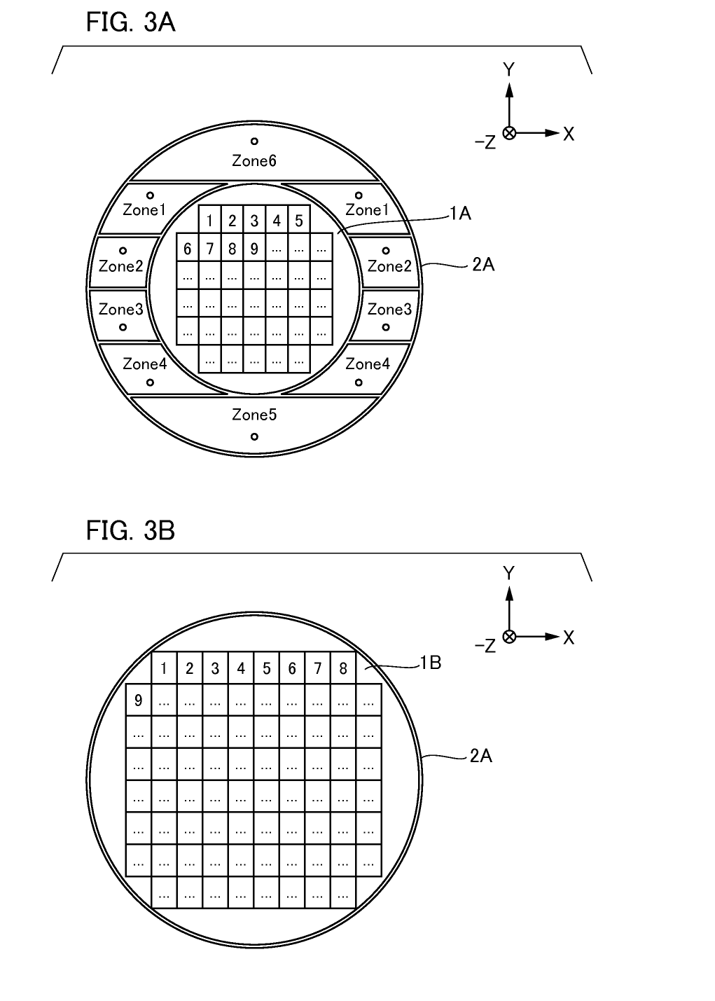

Next, an imprint operation by the above-described imprint apparatus will be described. First, the substrate 1 is mounted on the fine movement stage 2 and the coarse movement stage 3. The substrate 1 moves under the dispenser 7 which ejects the uncured resin at the fine movement stage 2 and the coarse movement stage 3 and is coated with a predetermined amount of resin by the dispenser 7. Next, the mold 5 is lowered by the vertical mold movement means 5a. Before the resin is subjected to UV curing while in contact with the substrate 1, relative position adjustment between the two is performed by overlapping the alignment mark of the mold 5 and the alignment mark on the substrate 1 in the fine movement stage 2 using the alignment scope 11. Next, the mold 5 is lowered in the direction of the substrate 1 by the vertical mold movement means 5a and the pattern of the mold 5 is pressed and transferred to the uncured resin. The UV light generating apparatus 6 radiates the UV light from the top and the UV light passes through the mold 5 and ultimately radiates the light to the uncured resin. In this step, the uncured resin is cured. Next, by retracting the mold 5 from the substrate 1 in a detachment direction, a resin layer patterned on the substrate 1 is formed and the imprint operation ends. This imprint operation is iterated, for example, in the continuous numerical order illustrated in FIGS. 3A and 3B, in a plurality of shot areas of the substrate

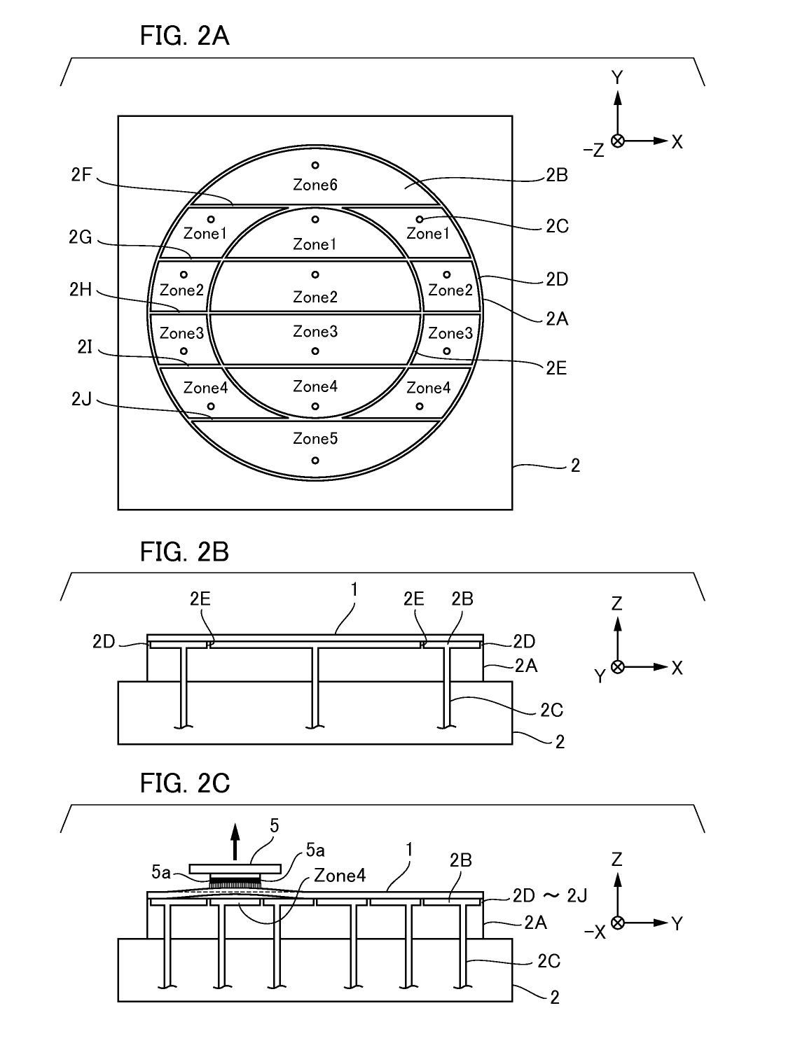

Next, a configuration of the substrate holder (substrate holding means) according to this embodiment will be described with reference to FIGS. 2A to 2C. FIG. 2A is a schematic diagram illustrating a configuration example of an attraction area (holding area) of the substrate holder 2A according to this embodiment. As illustrated in FIG. 2A, the substrate holder 2A is provided on the fine movement stage 2 and includes an attraction area 2B in which the substrate is attracted and held. The attraction area 2B is configured so that the attraction area 2B is divided into a plurality of attraction areas by a plurality of partition walls (boundaries) and pressure adjustment can be performed for each attraction area. Specifically, partition walls 2D are provided in an outermost circumference area of the substrate holder 2A, and the attraction area surrounded by the partition walls 2D can hold a substrate (second substrate) having a diameter of 450 mm (second external diameter). In addition, partition walls 2E are provided further inward than the partition walls 2D and an attraction area surrounded by the partition walls 2E can hold a substrate (first substrate) having a diameter of 300 mm (first external diameter). Actually, a state in which each of substrates having two different diameters is attracted and held is illustrated in FIG. 3. FIG. 3A illustrates a state in which a substrate 1A having a diameter of 300 mm is held by the substrate holder 2A. In addition, FIG. 3B illustrates a state in which a substrate 1B having a diameter of 450 mm is held by the substrate holder 2A. As described above, the substrate holder 2A can attract and hold each of the substrates having the two different diameters. Also, although the substrate holder corresponding to the two diameters of 450 mm and 300 mm is described as an example here, the diameters of the substrates and the number of substrates with which the substrate holder is compatible are not limited thereto. For example, the first external diameter may be designated as 200 mm, the second diameter may be designated as 300 mm, and an attraction area having a third external diameter that surrounds the attraction areas corresponding to the substrates of the first and second diameters may be further provided.

In this embodiment, the attraction area 2B of the substrate holder 2A is sub-divided into a plurality of areas. As illustrated in FIG. 2A, partition walls 2F to 2J are parallel straight lines(rectilinear boundary lines) arranged in a predetermined direction and partition walls 2F and 2J are circumscribed in an area surrounded by the partition walls 2E (intersect at one point) and connected to partition walls 2D. In addition, the partition walls 2G to 2I are connected to the partition walls 2D and 2E (intersect at two points). Accordingly, the attraction area in which the substrate having the diameter of 300 mm is attracted and held is divided into four attraction areas Zone1 to Zone4 defined by the partition wall 2E and three parallel partition walls 2G to 2I arranged in a predetermined direction. In addition, the attraction area in which the substrate having the diameter of 450 mm is attracted and held is divided into six attraction areas Zone1 to Zone6 to be defined by the partition wall 2E and the five parallel partition walls 2F to 2J arranged in a predetermined direction. Also, Zone1 to Zone4 of the attraction areas corresponding to the substrate having the diameter of 450 mm indicate all areas of a total of three locations including 1 provided for the substrate having the diameter of 300 mm and Zone1 of two locations provided for the substrate having the diameter of 450 mm as illustrated in FIG. 2A. According to this configuration, it is possible to locally adjust a force for attracting the substrate 1 in synchronization with a process within an imprint process. In addition, it is possible to provide a substrate holder by which processing can be facilitated and flatness can be controlled with high precision.

Further, in this embodiment, the aforementioned partition walls 2G to 2I are disposed in consideration of an area ratio of attraction areas surrounded by the partition walls 2E. Specifically, when each attraction area is divided in equal areas in a state in which the external diameter of the substrate 1 is a diameter of 300 mm (here, the substrate is actually formed to be reduced by 0.1 mm to 0.5 mm in consideration of the external diameter tolerance of the substrate 1), the width dimensions (intervals) of the attraction areas Zone1 and Zone4 become 89.4 mm. Here, the width dimensions of the attraction areas Zone1 and Zone4 are maximum distances from the partition walls 2G and 2I to the partition wall 2E. In addition, the width dimensions of the attraction areas Zone2 and Zone3 (distances from the partition walls 2G and 2I to the partition wall 2H) become 60.6 mm.

Next, a configuration in which an attraction force is generated for an attraction region of the substrate holder 2A (negative pressure is used) will be described. FIG. 2B is a cross-sectional view of an X-axis direction of FIG. 2A. As illustrated in FIG. 2B, the substrate holder 2A includes a vacuum pipe 2C for generating the attraction force for each attraction area. The vacuum pipe 2C is connected to each attraction area. As illustrated in FIG. 2A, the partition walls 2D to 2J form a shape in which the partition walls are closed in a plane and independent sealed spaces (attraction areas) are formed at the time of covering with the substrate 1. A pressure adjusting apparatus (not illustrated) is connected to each of these sealed spaces via the vacuum pipe 2C. This pressure adjusting apparatus is connected to a vacuum pump and compressor (not illustrated), so that the air pressure within each sealed space can be continuously switched. A control apparatus (not illustrated) can instruct the pressure adjusting apparatus to adjust the pressure within the sealed space in synchronization with a process within an imprint operation and locally adjust a force for attaching the substrate 1. FIG. 2C is a diagram illustrating a state in which the force for attracting the substrate 1 is locally adjusted, and is a cross-sectional view of a Y-axis direction of FIG. 2A. In this embodiment, it is possible to locally weaken the attraction force for the substrate 1 in relation to a position corresponding to a peeling position immediately before entering a peeling step on the substrate 1 because the pressure of each attraction area of the substrate holder 2A can be individually adjusted as described above. Thereby, as illustrated in FIG. 2C, the substrate 1 is locally raised in the peeling direction and a force for the peeling direction is in a state of equilibrium on the side of the mold 5 and the substrate side. At this time, because the substrate 1 and the mold 5 are mutually deformed in convex shapes in the outer periphery of a portion in a contact state by a resin, peeling tends to occur in the outer periphery of a contact portion. Accordingly, although a large peeling force is required when the entire surface of the contact portion is peeled at once, it is possible to gradually perform peeling at a small peeling force of ½ to 1/10 by making a state in which peeling from the periphery tends to occur.

Hereinafter, advantages of specifying the attraction area of the substrate holder 2A by its area ratio as described above will be described in comparison with the case in which the attraction area is specified by its interval. When an area inward from the partition wall 2E is considered in FIG. 2A, an area ratio of Zone1:Zone2:Zone3:Zone4 becomes 61:96:96:61 when a circular attraction area is divided into four divisions by parallel lines of equal intervals. The areas Zone1 and Zone4 with narrow areas are 36% narrower than the areas Zone2 and Zone3 with wide areas. For example, when an attraction area of a substrate having an external diameter which is a diameter of 300 mm is divided at equal intervals, all intervals of the parallel lines are 75 mm. At this time, areas of attraction areas become 138 cm², 215 cm², 215 cm², and 138 cm². On the other hand, when the attraction area is divided in equal areas, areas of division areas all become 177 cm² by dividing an area of a circle having a diameter of 300 mm by 4. Intervals of parallel lines for dividing the area by 4 become 89.41 mm, 60.59 mm, 60.59 mm, and 89.41 mm, and a width dimension differs according to a position in a direction.

As described above, it is possible to favorably execute peeling by weakening the attraction force for the substrate 1 in relation to a corresponding area in a peeling step of the substrate 1 and the mold 5. Thus, for example, when there is a shot of the peeling step in a boundary portion between Zone2 and Zone3 in an area inside the partition wall 2E of FIG. 2A, the substrate 1 is configured to be fixed by only the attraction forces of Zone1 and Zone4 by opening the attraction forces of the areas Zone2 and Zone3. At this time, the attraction area becomes 276 cm² in divisions of equal intervals and becomes 354 cm² in the equal-area division. Accordingly, the area ratio of the attraction areas becomes 1.3 in the equal-area division and the equal-interval division, and the strong attraction force that is 1.3 times the attraction force for the equal-area division is obtainable. In addition, even when areas over which the shot extends are in another combination in the case of the equal-area division, a total area of the remaining two areas is constant and the attraction force is not strengthened or weakened. When the attraction area is divided as described above, a shot area does not extend over three or more attraction areas because a size of the shot area (a diagonal distance at most) is less than a size of each attraction area. That is, the shot area extends over only two attraction areas at most. That is, it is possible to constantly fix the substrate 1 with a strong attraction force in an area of ½ or more of the entire substrate 1. Also, although the case in which the attraction area surrounded by the partition wall 2E of the substrate holder 2A is divided in equal areas has been described, the present invention is not necessarily limited to the case in which the attraction area is divided in the equal areas, and the attraction area may be divided at an area ratio close to the equal areas. Specifically, it is preferable that an area ratio P of two attraction areas having different width dimensions among a plurality of attraction areas of the substrate holder 2A be in a range of 0.8 to 1.2 and it is further preferable that the area ratio P be in a range of 0.9 to 1.1. Because it is possible to set an area of ½ or more of the entire substrate 1 as the attraction area according to the range of the area ratio, it is possible to effectively prevent the substrate 1 from being peeled from the substrate holder 2A.

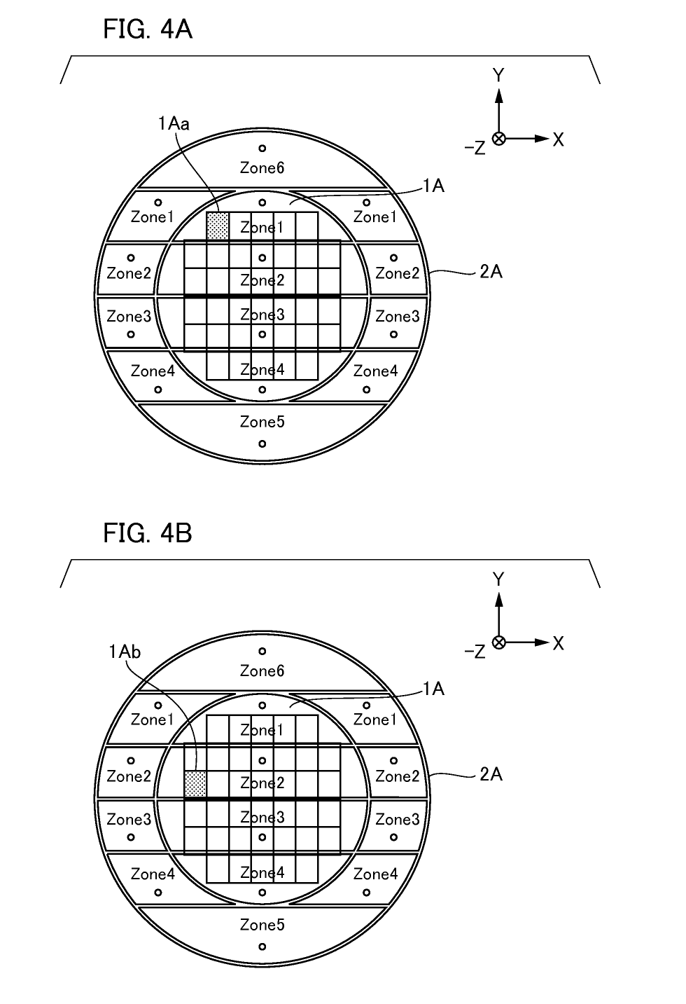

Hereinafter, switching of the position of the shot and the attraction pressure of the substrate holder 2A for the substrate having a diameter of 300 mm will be described. As illustrated in FIG. 4A, the outer circumference of a shot 1Aa is included in an attraction area Zone1 when the imprint is performed on the shot 1Aa of the substrate 1A having the diameter of 300 mm attracted and held by the substrate holder 2A. At this time, by switching the internal pressure of the attraction area Zone1 to pressure higher than that during normal attraction and weakening the attraction force, a portion corresponding to the attraction area Zone1 of the substrate 1A is raised in a mold release direction when the mold 5 is released and has little deformation. Thereby, it is possible to improve mold release characteristics of the mold 5 and the substrate 1A and release the mold with a smaller release force. Likewise, when the imprint is performed on the shot 1Ab as illustrated in FIG. 4B, it is only necessary to weaken the attraction force by switching the internal pressure of the attraction area Zone2 to the pressure higher than that during the normal attraction because the outer circumference of the shot 1Ab is also included in the attraction area Zone2. At this time, a portion corresponding to the attraction area Zone2 of the substrate 1A is raised in a mold release direction when the mold 5 is released and has little deformation, so that it is possible to improve mold release characteristics of the mold 5 and the substrate 1A and release the mold with a smaller release force.

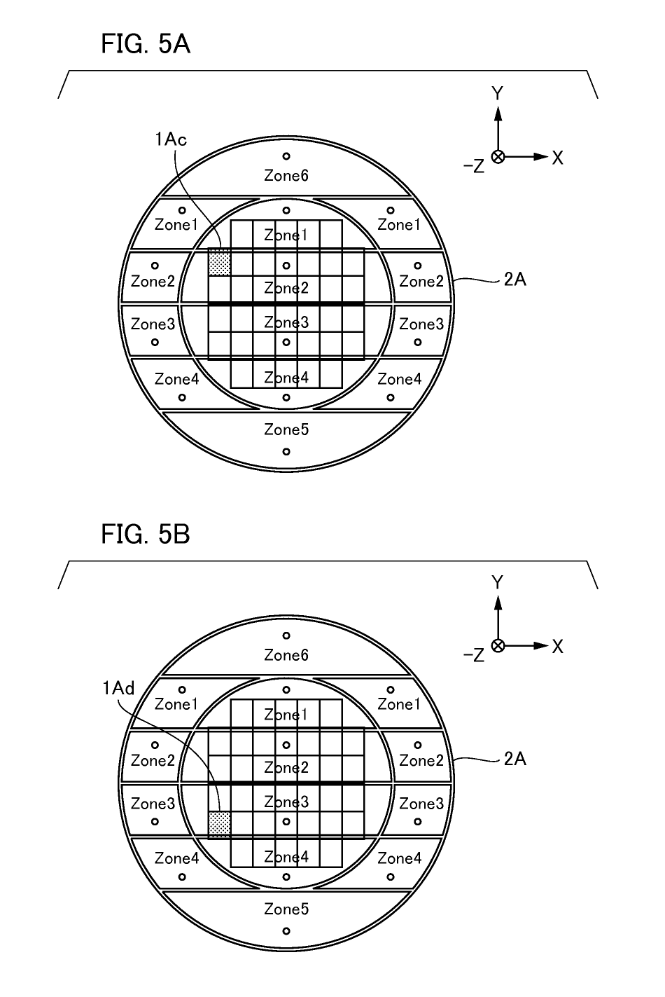

Next, switching of the attraction pressure when the shot extends over two attraction areas will be described. As illustrated in FIG. 5A, the outer circumference of a shot 1Ac extends over attraction areas Zone1 and Zone2 when the imprint of the shot 1Ac is performed. At this time, the attraction force is weakened by switching the internal pressures of the attraction areas Zone1 and Zone2 to a pressure higher than that during normal attraction. Thereby, portions corresponding to the attraction areas Zone1 and Zone2 of the substrate 1A are raised in a mold release direction when the mold 5 is released and have little deformation, so that it is possible to improve mold release characteristics of the mold 5 and the substrate 1A and release the mold with a smaller release force. Also, even when the attraction forces of the attraction areas Zone1 and Zone2 are weakened, it is possible to prevent the substrate 1A from being peeled or moved from the substrate holder 2A because an area of ½ or more of the substrate holds the substrate 1A with a strong attraction force according to the attraction areas Zone3 and Zone4. Likewise, as illustrated in FIG. 5B, the outer circumference of a shot 1Ad extends over attraction areas Zone3 and Zone4 when the imprint of the shot 1Ad is performed. Thus, it is only necessary to weaken the attraction force by switching the internal pressures of the attraction areas Zone3 and Zone4 to a pressure higher than that during normal attraction. Portions corresponding to the attraction areas Zone3 and Zone4 of the substrate 1A are raised in a mold release direction when the mold 5 is released and have little deformation, so that it is possible to improve mold release characteristics of the mold 5 and the substrate 1A and release the mold with a smaller release force. Also, even when the attraction forces of the attraction areas Zone3 and Zone4 are weakened, an area of ½ or more of the substrate holds the substrate 1A with a strong attraction force according to the attraction areas Area1 and Zone2. Thus, it is possible to prevent the substrate 1A from being peeled or moved from the substrate holder 2A.

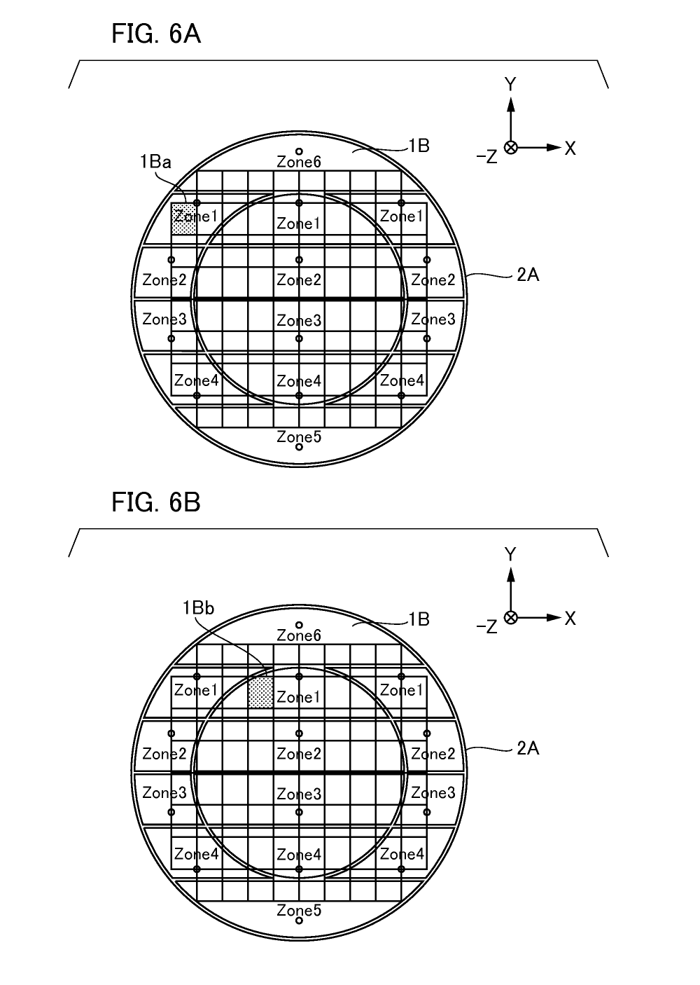

Likewise, switching of the position of the shot and the attraction pressure of the substrate holder 2A for the substrate having a diameter of 450 mm will be described. As illustrated in FIG. 6A, the outer circumference of a shot 1Ba is included in an attraction area Zone1 when the imprint is performed on the shot 1Ba of the substrate 1B having the diameter of 450 mm attracted and held by the substrate holder 2A. At this time, by switching the internal pressure of the attraction area Zone1 to pressure higher than that during normal attraction and weakening the attraction force, a portion corresponding to the attraction area Zone1 of the substrate 1B is raised in a mold release direction when the mold 5 is released and has little deformation. Thereby, it is possible to improve mold release characteristics of the mold 5 and the substrate 1B and release the mold with a smaller release force. Here, as described above, the area Zone1 indicates all three locations including Zone1 provided for the substrate having the diameter of 300 mm and Zone1 of two locations provided for the substrate having the diameter of 450 mm. In addition, because the outer circumference of the shot 1Bb is included in the attraction area Zone1 even when the imprint is performed on the shot 1Bb as illustrated in FIG. 6B, this is similar to the case in which the above-described imprint of the shot 1Ba is performed. By switching the internal pressures of the attraction areas Zone1 formed from a total of three locations to pressure higher than that during normal attraction and weakening the attraction force, a portion corresponding to the attraction area Zone1 of the substrate 1B is raised in a mold release direction when the mold 5 is released and has little deformation. Thereby, it is possible to improve mold release characteristics of the mold 5 and the substrate 1B and release the mold with a smaller release force. Also, when the shot 1Bb is included in Zone1 corresponding to a substrate having a diameter of 300 mm, the adjustment of the attraction pressure is performed using only a area surrounded by the attraction area corresponding to the substrate having a diameter of 300 mm, that is, the partition wall 2E.

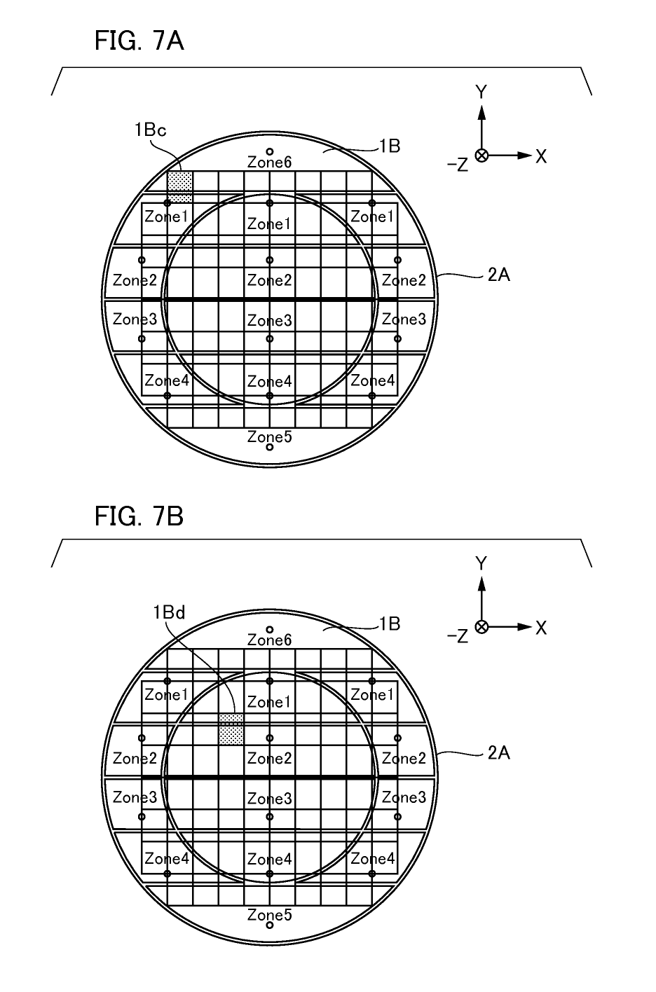

Next, switching of the attraction pressure when the shot extends over two attraction areas even for the substrate having the diameter of 450 mm will be described. As illustrated in FIG. 7A, the outer circumference of a shot 1Bc extends over attraction areas Zone1 and Zone6 when the imprint of the shot 1Bc is performed. At this time, the attraction force is weakened by switching the internal pressures of the attraction areas Zone1 and Zone6 to pressure higher than that during normal attraction. Thereby, portions corresponding to the attraction areas Zone1 and Zone6 of the substrate 1B are raised in a mold release direction when the mold 5 is released and have little deformation. Then, it is possible to improve mold release characteristics of the mold 5 and the substrate 1B and release the mold with a smaller release force. Also, even when the attraction forces of the attraction areas Zone1 and Zone6 are weakened, at least an area of ½ or more of the substrate holds the substrate with a strong attraction force according to the attraction areas Zone2 to Zone5. Thus, it is possible to prevent the substrate 1B from being peeled or moved from the substrate holder 2A. Likewise, as illustrated in FIG. 7B, the outer circumference of a shot 1Bd extends over attraction areas Zone1 and Zone2 even when the imprint is performed on the shot 1Bd. Thus, it is only necessary to weaken the attraction force by switching the internal pressures of the attraction areas Zone1 and Zone2 to pressure higher than that during normal attraction. Portions corresponding to the attraction areas Zone1 and Zone2 of the substrate 1B are raised in a mold release direction when the mold 5 is released and have little deformation, so that it is possible to improve mold release characteristics of the mold 5 and the substrate 1B and release the mold with a smaller release force. Also, even when the attraction forces of the attraction areas Zone1 and Zone2 are weakened, at least an area of ½ or more of the substrate holds the substrate with a strong attraction force according to the attraction areas Zone3 to Zone6. Thus, it is possible to prevent the substrate 1B from being peeled or moved from the substrate holder 2A.

As described above, according to this embodiment, it is possible to provide an imprint apparatus in which one substrate holder can be shared between substrates having different sizes. Further, it is possible to provide an imprint apparatus which includes a substrate holder by which processing can be facilitated and flatness can be controlled with high precision and can suppress the peeling or deviation of the substrate in an imprint process.

### Article Manufacturing Method

A method of manufacturing article such as the aforementioned device (e.g., a microchip, a liquid crystal display) according to an embodiment of the present invention may include a step of forming a pattern on an object (e.g., wafer, glass plate, film substrate) using the aforementioned imprint apparatus. Furthermore, the article manufacturing method may include other known steps (oxidizing, film forming, vapor depositing, doping, flattening, etching, resist peeling, dicing, bonding, packaging, and the like). The article manufacturing method of this embodiment has an advantage, as compared with a conventional article manufacturing method, in at least one of performance, quality, productivity and production cost of a device.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-101918 filed May 16, 2014, which is hereby incorporated by reference herein in its entirety.

1. An imprint apparatus that forms patterns on a substrate by bringing a resin applied onto the substrate into contact with a mold, the apparatus comprising:
a substrate holder configured to hold the substrate,
wherein the substrate holder includes a plurality of holding areas arranged in a predetermined direction, and
wherein shapes of the plurality of holding areas are defined to be capable of holding a first substrate in a first external diameter and a second substrate in a second external diameter different from the first external diameter.

2. The imprint apparatus according to claim 1, wherein a first holding area capable of holding the first substrate is included in a same plane as a second holding area capable of holding the second substrate.

3. The imprint apparatus according to claim 2,
wherein the plurality of holding areas are further defined by a rectilinear boundary arranged in a predetermined direction.

4. The imprint apparatus according to claim 3,
wherein the first holding area capable of holding the first substrate has a width dimension of the direction differing according to a position in the direction, and
wherein an area ratio of two holding areas having different width dimensions among the plurality of holding areas is within a range of 0.8 to 1.2.

5. The imprint apparatus according to claim 2,
wherein the second holding area capable of holding the second substrate is further defined by a rectilinear boundary in a predetermined direction, and
wherein the rectilinear boundary is circumscribed in the first holding area capable of holding the first substrate.

6. The imprint apparatus according to claim 1, wherein the substrate holder is configured to hold the substrate using negative pressure.

7. A method of manufacturing an article, the method comprising: patterning a substrate using the an imprint apparatus comprising:
a substrate holder configured to hold the substrate,
wherein the substrate holder includes a plurality of holding areas arranged in a predetermined direction, and
wherein shapes of the plurality of holding areas are defined to be capable of holding a first substrate in a first external diameter and a second substrate in a second external diameter different from the first external diameter, and processing the patterned substrate to manufacture the article.
